(19) United States
(12) Patent Application Publication
(10) Pub. No.: US 2011/0003188 A1
(43) Pub. Date: Jan. 6, 2011

(54) ENERGY STORAGE DEVICE

(76) Inventors: Bruce C. H. CHENG, Taoyuan Hsien (TW); Chieh-Lin HSING, Taoyuan Hsien (TW); Chih-Hao KAN, Taoyuan Hsien (TW)

Correspondence Address: Muncy, Geissler, Olds & Lowe, PLLC, 4000 Legato Road, Suite 310, FAIRFAX, VA, 22033, US

(21) Appl. No.: 12/830,994

(22) Filed: Jul. 6, 2010

Related U.S. Application Data
(60) Provisional application No. 61/223,265, filed on Jul. 6, 2009.

(51) Int. Cl. H01M 10/50

(52) U.S. Cl. 429/120

(57) ABSTRACT

A structure of energy storage device, including a plurality of rechargeable batteries disposed in a row with a distance to each other, and a heat dissipating structure firmly inserted accordingly between the rechargeable batteries. The heat dissipating structure is a heat dissipating medium of the energy storage device.

### CROSS REFERENCE TO RELATED APPLICATIONS

This application claims the benefit of U.S. Provisional Application No. 61/223,265 filed Jul. 6, 2009, the entirety of which is incorporated by reference herein.

### BACKGROUND OF THE INVENTION

1. Field of the Invention

The invention relates to an energy storage device, and especially to an energy storage device having a rechargeable battery assembly adapting a heat dissipation structure.

2. Description of the Related Art

Rechargeable batteries (or so called secondary batteries) in the market are usually packed into energy storage devices or modules, and then connected to outer heat conductive mechanisms, such as metal terminals, to achieve heat dissipation objectives. However, when such a battery is extraordinarily fast charged or fast discharged under a high current, a large amount of heat produced within the module will not be able to be conducted outwardly fast enough.

For example, for a Lithium-ion Battery, LIB, under high temperature conditions, when a charging/discharging operating life span test was conducted, the operating life span and capacity thereof decreased greatly. That is, temperature was a major variable effecting capacity of such kind of batteries. Hence, when temperature accumulation occurs, the phenomenon hinders battery efficiency and shortens the operating life span of a battery.

### BRIEF SUMMARY OF THE INVENTION

In view of the foregoing, the objective of the invention is to provide an energy storage device having high heat dissipating efficiency.

To achieve the above, the present invention combines an energy storage device having a plurality of rechargeable batteries (or cells) and a plurality of super capacitors, wherein the rechargeable batteries are separately interlaced by the super capacitors. Hence, heat generated by the rechargeable batteries will be conducted to adjacent super capacitors, wherein the adjacent super capacitors have relatively lower temperatures than that of the rechargeable batteries. Therefore, the overall temperature of the rechargeable batteries will be spread more homogeneously, to hinder heat accumulation from occurring.

As mentioned above, because heat generated by the rechargeable batteries can be effectively conducted by the super capacitors, heat accumulation will not occur, so that the energy storage device remains effective.

A detailed description is given in the following embodiments with reference to the accompanying drawings.

### BRIEF DESCRIPTION OF THE DRAWINGS

The invention can be more fully understood by referring to the following detailed description and examples with references made to the accompanying drawings, wherein:

FIG. 1A shows a schematic view of an embodiment of an energy storage device in the present invention;

FIG. 1B shows a schematic view of another embodiment of an energy storage device in the present invention.

FIG. 2 shows a schematic view of still another embodiment of an energy storage device in the present invention;

FIG. 3A is a top-view of an exemplary embodiment of an energy storage device;

FIG. 3B is a cross section of an exemplary embodiment of an energy storage device; and

FIGS. 4A and 4B show temperature characteristics of the energy storage device.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

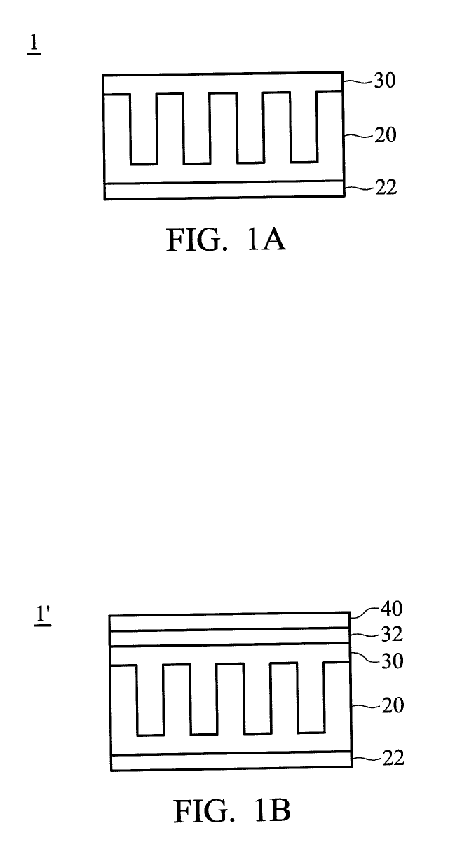

With reference to FIG. 1A, for an embodiment of an energy storage device of the present invention, the energy storage device 1 comprises a plurality of rechargeable batteries 20 and a heat dissipating structure 30. Each of the rechargeable batteries 20, for example, looks like a slim cuboid. The rechargeable batteries 20 are applied to be disposed in a row with a plurality of intervals to each other on a first substrate 22, wherein the intervals between the rechargeable batteries 20 are kept at a finite and proper distance so as to form a plurality of comb-like structures for dissipating heat generated by the rechargeable batteries 20. The heat dissipating structure 30 is adapted to be contacted to the rechargeable batteries 20 so as to dissipate heat generated by the rechargeable batteries 20. The heat dissipating structure 30 is substantially a comb-like figure and is applied to closely contact and be firmly inserted accordingly between the rechargeable batteries 20. Besides, with reference to FIG. 1B, another embodiment of the energy storage device, a heat dissipating structure 30 is further connected to a second substrate 32 so as to conduct heat generated from the rechargeable batteries 20 to the second substrate 32, and then the heat is, for example, dissipated from a surface of the second substrate 32, wherein the surface faces adjacent environment so as to dissipate heat directly and quickly.

The above-mentioned rechargeable batteries 20 (or so called secondary batteries) may be selected from at least one of a list comprising a NiCd battery, NiMn battery, NiZn battery, Nickel Hydrogen battery, Nickel ion-based battery, Lithium ion-based battery, solid-state Lithium battery, Lead acid battery , or the combination thereof, etc. However, as technology advances the variations of rechargeable batteries will increase; thus, all embodiments are not included herein, since a user in the art may easily expand upon mentioned applications. The heat dissipating structure 30 is selected from a set of heat sink, heat spreader, or other suitable devices or elements made of thermal conducting materials. In an embodiment, a set of a super capacitor is adapted as the heat dissipating structure 30 due to the general high heat conducting character of common super capacitors. Please refer to FIG. 1B again, the heat dissipating structure 30 connects to an auxiliary device 40 for further heat dissipation. The auxiliary device 40 is, for example, a heat sink, a heat pipe, a water tank, a water cooling system, a thermoelectric cooler, a fan, a blower, or a thermal pack on the surface of the second substrate 32 so as to enhance heat dissipating efficiency.

In this embodiment, the first substrate 22 and the second substrate 32 are made of high thermal conducting material. In some embodiments, the high thermal conducting material comprises thermal conducting polymer, metal, silicon substrate, carbon, carbon-based derivatives, thermoelectric cooler, or the combination thereof.

In an embodiment, heat is dissipated by convection, wherein a temperature gradient occurs inside of a system, and heat is conducted through the heat dissipating structure 30 to the surrounding environment, wherein the heat generated mainly due to the heat generated by the rechargeable batteries 20, and the heat dissipating structure 30 comprises a heat sink, a heat spreader, or a super capacitor as previously mentioned.

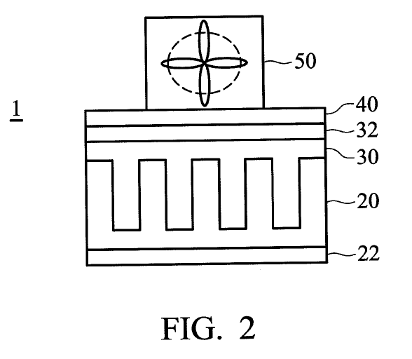

In still another embodiment of the present invention, heat is dissipated by forced convection, wherein a temperature gradient occurs inside of the system, and heat is conducted through the heat dissipating structure to the surrounding environment. Please refer to FIG. 2, wherein the heat generated is mainly due to the heat generated from the rechargeable batteries 20, and the heat dissipating structure 30 comprises a heat sink, a heat spreader, or a super capacitor as previously mentioned and further comprises an outer cooling system 50, wherein the cooling system 50 is, for example, a fan, a blower, or an auxiliary cooling system connected to the outside of the second substrate 32.

Please refer to FIG. 1 and FIG. 2, wherein the recharged batteries 20 and the heat dissipating structure 30 are, for example, formed as a pair of comb-like structures. The above-mentioned comb-like rechargeable batteries 20 and the comb-like heat dissipating structure 30 of the energy storage device 1 are arranged to join with each other. There is a phenomenon that during the charging and/or discharging process the temperature of the rechargeable batteries 20 will be changed violently, but the temperature of the heat dissipating structure 30 which, for example, made of super capacitor will not. Hence, if the rechargeable batteries 20 and the heat dissipating structure 30 are produced like a pair of comb-like structures, for example, the heat generated by the rechargeable batteries 20 will be conducted from a direction to the adjacent heat dissipating structure 30, and then be conducted through the heat dissipating structure 30 to the surrounding environment, wherein the heat dissipating structure 30 is a super capacitor, for example. Therefore, the thermal accumulation does not occur inside of the rechargeable batteries 20, such that hotspots will not occur and the overall temperature of the energy storage device 1 is able to achieve fast homogeneous temperature distribution.

In summary, this invention discloses an energy storage device, wherein the rechargeable batteries and the heat dissipating structure have close contact there between so as to conduct heat more efficiently and directly. Besides, choosing super capacitor material as the heat dissipating medium or so called thermal spreader, heat dissipating efficiency can be further enhanced. Further, super capacitor material has excellent thermal conductivity and heat endurance (working temperature of up to 65° C.), such that the super capacitor is suitable to be applied as a heat dissipating medium for rechargeable batteries.

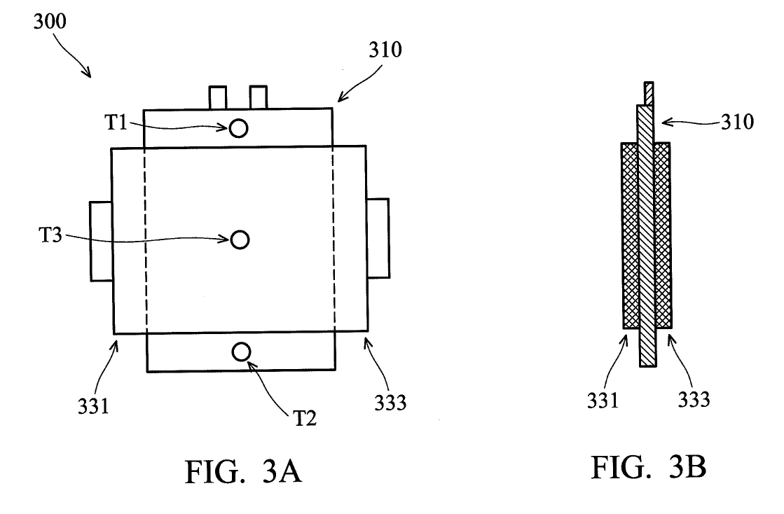

FIG. 3A is a top-view of an exemplary embodiment of an energy storage device. FIG. 3B is a cross section of an exemplary embodiment of an energy storage device. The energy storage device 300 comprises a rechargeable battery 310 and super capacitors 331 and 333. In this embodiment, the rechargeable battery 310 is a lithium battery, but the disclosure is not limited thereto.

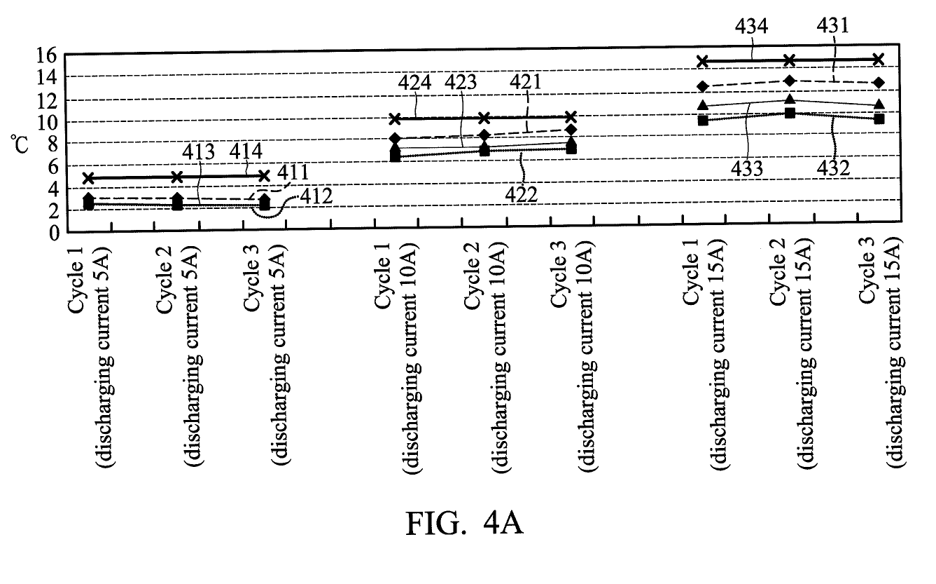

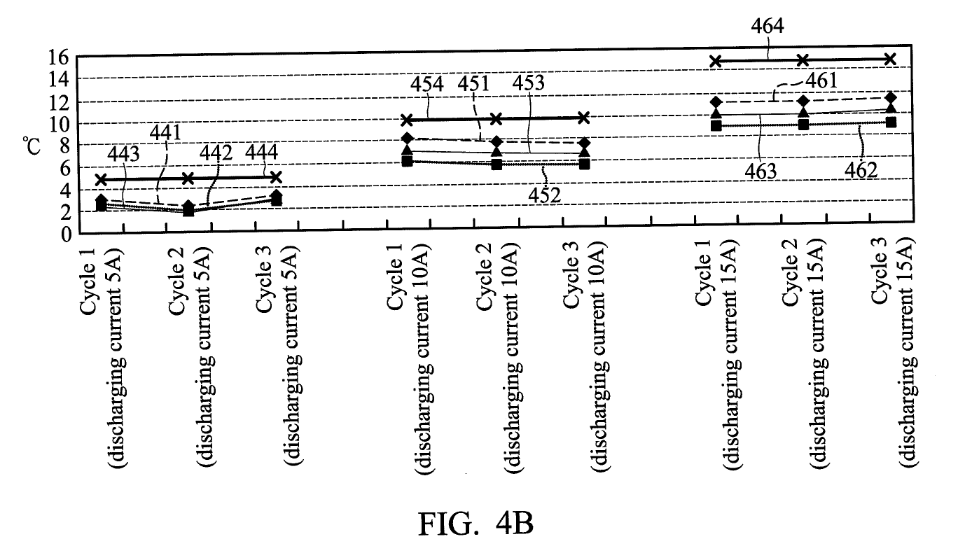

FIG. 4A shows a temperature characteristic of the energy storage device. In this embodiment, when the rechargeable battery 310 was charged or discharged, the super capacitors 331 and 333 were not charged or discharged. During discharging period, the terminals T1˜T3 are measured. The curves 411˜413, 421˜423 and 431˜433 are formed according to the measured results.

Since the forming methods of the curves 411˜413, 421˜423 and 431˜433 are the same, the curve 411 is given as an example. Before the rechargeable battery 310 was discharged, the temperature of the terminal Ti is measured to generate a first measuring result. After the rechargeable battery 310 was discharged and the discharged current was approximately 5A, the temperature of the terminal T1 is again measured to generate a second measuring result. A point of the curve 411 is obtained according to the difference between the first and the second measuring results. The discharging action is executed three times such that three points can be obtained and then the curve 411 is formed.

In FIG. 4A, the curve 414 represents the temperature of a conventional rechargeable battery. Before the conventional rechargeable battery was discharged, the temperature of the conventional rechargeable battery is measured to generate. After the conventional rechargeable battery was discharged and the discharged current was approximately 5A, the temperature of the conventional rechargeable battery is again measured. The curve 414 is formed according to the measuring results of the conventional rechargeable battery.

The following description is a charging action and a discharging action of the rechargeable battery 310. First, the rechargeable battery 310 was fully charged to 4.2V. The charging current was approximately 5A. After 10 minutes, the rechargeable battery 310 was discharged. The temperatures of the terminals T1-T3 were measured when the rechargeable battery 310 started to discharge. When the voltage of the rechargeable battery 310 was decreased to 2.8V, the discharging action was stopped and the temperatures of the terminals T1-T3 were again measured. The discharging current was approximately 5A, 10A or 15A. The different discharging current can obtain the different temperature curves, such as the curves 411˜414, 421˜424 and 431˜434.

FIG. 4B shows another temperature characteristic of the energy storage device. In this embodiment, when the rechargeable battery 310 was charged or discharged, the super capacitors 331 and 333 were charged or discharged. During discharging period of the rechargeable battery 310, the terminals T1˜T3 are measured to generate curves 441˜443, 451˜453 and 461˜463. Since the forming methods of the curves 441˜444, 451˜454 and 461˜464 are the same as that of the curves 411˜414, 421˜424 and 431˜434, descriptions of the curves 441˜444, 451˜454 and 461˜464 are omitted for brevity.

In this embodiment, first, the rechargeable battery 310 was fully charged to 4.2V. The charging current was approximately 5A. After 10 minutes, the rechargeable battery 310 was discharged. The temperatures of the terminals T1-T3 were measured, as shown in FIG. 4B, when the rechargeable battery 310 star. When the voltage of the rechargeable battery 310 was decreased to 2.8V, the discharging action was stopped and the temperatures of the terminals T1-T3 were again measured. The discharging current was approximately 15A.

When charging or discharging the rechargeable battery 310, the super capacitors 331 and 333 were continuously charged or discharged. When the voltage of the super capacitors 331 and 333 reached 1.3V, the action of charging the super capacitors 331 and 333 was stopped. The charging current of the super capacitors 331 and 333 were approximately 5 A. After 15 seconds, the super capacitors 331 and 333 were discharged. When the voltage of the super capacitors 331 and 333 was decreased to 0.2V, the action of discharging the super capacitors 331 and 333 was stopped. The discharging current of the super capacitors 331 and 333 were approximately 5 A. After 5 seconds, the super capacitors 331 and 333 were again charged and then discharged.

As shown in FIGS. 4A and 4B, temperature difference of FIG. 4B is smaller than temperature difference of FIG. 4A. The results show that heat accumulation was reduced when the super capacitors were charged or discharged.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An energy storage device, comprising:
a plurality of rechargeable batteries being disposed in a row with a distance to each other on a first substrate; and
a heat dissipating structure being adapted to the rechargeable batteries to dissipate heat generated by the rechargeable batteries, wherein the heat dissipating structure is firmly inserted between the rechargeable batteries.

2. The energy storage device according to claim 1, wherein the rechargeable battery comprises a NiCd battery, NiMn battery, NiZn battery, Nickel Hydrogen battery, Nickel ion-based battery, Lithium ion-based battery, solid-state Lithium battery, Lead acid battery, or the combination thereof.

3. The energy storage device according to claim 1, wherein the heat dissipating structure comprises a plurality of heat sink and the rechargeable batteries are separately interlaced by the heat sinks.

4. The energy storage device according to claim 1, wherein the heat dissipating structure comprises a plurality of heat spreader and the rechargeable batteries are separately interlaced by the heat spreaders.

5. The energy storage device according to claim 1, wherein the heat dissipating structure comprises a plurality of super capacitors and the rechargeable batteries are separately interlaced by the super capacitors.

6. The energy storage device according to claim 1, wherein the heat dissipating structures is connected to a second substrate.

7. The energy storage device according to claim 6, wherein the first substrate and the second substrate are made of high thermal conducting material.

8. The energy storage device according to claim 7, wherein the high thermal conducting material comprises thermal conducting polymer, metal, silicon substrate, carbon, carbon-based derivatives, thermoelectric cooler, or the combination thereof.

9. The energy storage device according to claim 1, wherein the heat dissipating structure is connected to a heat sink, heat pipe, water tank, water cooling system, thermoelectric cooler, fan, blower, or thermal pack.

10. An energy storage device, comprising:
a laminated rechargeable battery; and
a heat dissipating structure being pasted to the rechargeable battery to dissipate heat generated by the rechargeable battery.

11. The energy storage device according to claim 10, wherein the rechargeable battery comprises a NiCd battery, NiMn battery, NiZn battery, Nickel Hydrogen battery, Nickel ion-based battery, Lithium ion-based battery, solid-state Lithium battery, Lead acid battery, or the combination thereof.

12. The energy storage device according to claim 10, wherein the heat dissipating structure is a heat sink.

13. The energy storage device according to claim 10, wherein the heat dissipating structure is a heat spreader.

14. The energy storage device according to claim 10, wherein the heat dissipating structure is a super capacitor.

15. The energy storage device according to claim 10, wherein the first substrate and the second substrate are made of high thermal conducting material.

16. The energy storage device according to claim 15, wherein the high thermal conducting material comprises thermal conducting polymer, metal, silicon substrate, carbon, carbon-based derivative, thermoelectric cooler, or the combination thereof.
